(19) United States
(12) Patent Application Publication
(10) Pub. No.: US 2026/0340039 A1
(43) Pub. Date: Oct. 29, 2026

(54) INFORMATION PROCESSING DEVICE, INFORMATION PROCESSING METHOD, AND PROGRAM

(71) Applicant: NTT TechnoCross Corporation, Tokyo (JP)

(72) Inventors: Hosana KAMIYAMA, Tokyo (JP); Kenichi MACHIDA, Tokyo (JP); Kazuhira MATSUI, Tokyo (JP)

(73) Assignee: NTT TechnoCross Corporation, Tokyo (JP)

(21) Appl. No.: 19/113,374

(22) PCT Filed: Oct. 7, 2022
(86) PCT No.: PCT/JP2022/037722

§ 371 Date: Mar. 19, 2025

(51) Int. Cl. G06F 16/9032; G06F 16/2457; G06F 16/903; G06F 16/9038; H04M 3/51

(52) U.S. Cl. CPC G06F 16/90332; G06F 16/24578; G06F 16/90344; G06F 16/9038; H04M 3/51

(57) ABSTRACT

An information processing device according to an aspect of the present disclosure includes an extraction unit configured to extract, in response to a selection operation on a first display part configured to express a text in a unit of an utterance in a conversation between a plurality of persons, a predetermined first character string from a text expressed by the first display part on which the selection operation is performed; and a search unit configured to perform search, based on a search key that is the extracted first character string, of knowledge expressing information for supporting a response to an inquiry in the conversation.

### TECHNICAL FIELD

The present disclosure relates to an information processing device, an information processing method, and a program.

### BACKGROUND ART

Techniques of supporting operators' responses by telephone at contact centers (also referred to as call centers) are known (e.g., Non-Patent Document 1). Such techniques generally provide operators with a UI (user interface) referred to as a response support screen or the like, and thus the operators can utilize various functions on this response support screen.

One of the functions that are utilizable by operators on the response support screen is a function that enables operators to perform search of knowledge, such as searching FAQs (Frequently Asked Questions) and the like. Another one of these functions is a function of automatically extracting a keyword from voice recognition results during a call with a customer, followed by searching of knowledge, and providing operators with knowledge for an inquiry from a customer from the knowledge obtained as the search result.

### RELEVANT ART DOCUMENTS

### Non-Patent Documents

Non-Patent Document 1: ForeSight Voice Mining, Internet <URL: https://www.ntt-tx.co.jp/products/foresight_vm/>

### SUMMARY OF THE INVENTION

### Problem to be Solved by the Invention

However, operators were not able to obtain appropriate knowledge in a short time. For example, when an operator searches knowledge, the operator needs to copy a keyword from voice recognition results and input the keyword into a search area. As a result, while appropriate knowledge is obtained, it takes time to obtain such knowledge. Also, for example, when a keyword is automatically extracted from voice recognition results to perform search of knowledge and provide such knowledge, an operator can obtain knowledge in a short time, but the obtained knowledge may be inappropriate.

The present disclosure has been made in view of the above, and it is an object of the present disclosure to provide a technique by which appropriate knowledge is obtainable in a short time.

### Means For Solving the Problem

An information processing device according to an aspect of the present disclosure includes: an extraction unit configured to extract, in response to a selection operation on a first display part configured to express a text in a unit of an utterance in a conversation between a plurality of persons, a predetermined first character string from a text expressed by the first display part on which the selection operation is performed; and a search unit configured to perform search, based on a search key that is the extracted first character string, of knowledge expressing information for supporting a response to an inquiry in the conversation.

### Advantageous Effects of the Invention

A technique by which appropriate knowledge is obtainable in a short time is provided.

### BRIEF DESCRIPTION OF THE DRAWINGS

FIG. 1 is a diagram illustrating an example of an entire configuration of a contact center system according to the present embodiment.

FIG. 2 is a diagram illustrating an example of a functional configuration of a response support system and an operator terminal according to the present embodiment.

FIG. 3 is a sequence diagram illustrating an example of a response support process according to the present embodiment.

FIG. 4 is a diagram illustrating an example of the response support screen (Part 1).

FIG. 5 is a diagram illustrating an example of the response support screen (Part 2).

FIG. 6 is a diagram illustrating an example of the response support screen (Part 3).

FIG. 7 is a diagram describing an example of a relationship between a position at which a selection operation is performed on an utterance part, and an extracted keyword.

### EMBODIMENTS FOR CARRYING OUT THE INVENTION

Hereinafter, embodiments of the present invention will be described. The embodiments are intended for contact centers, specifically, a contact center system 1 in which operators can obtain appropriate knowledge in a short time. However, the contact center is merely an example, and is by no means a limitation. For example, the embodiments are intended for locations other than contact centers, such as offices, stores, and the like, and are similarly applicable, for example, when a sales person, a contact person, and the like for goods, services, or the like obtains knowledge in their tasks. In general, the embodiments are similarly applicable when someone (who may be a single person or a plurality of persons) obtains knowledge during a conversation between a plurality of persons.

The following will be described assuming that operators at the contact center perform their tasks, such as, for example, answering inquiries from customers by voice call. However, this is by no means a limitation. The embodiments are similarly applicable when the operators perform their tasks by text chat (including chats in which stamps, attached files, or the like can be transmitted and received in addition to texts), video call, or the like.

Here, the term “knowledge” refers to information necessary for answering an inquiry or supporting the answering. Typically, for example, information obtained from searching in FAQs corresponds to the knowledge. In addition, for example, information from manuals and Web pages corresponds to the knowledge.

In recent years, as online business becomes increasingly popular and the tasks at contact centers increase, variations of inquiries increase and contents of operators' answers are diversified. At contact centers, operators are required to answer inquiries in a short time. Therefore, by introducing the contact center system 1 according to the present embodiment and enabling operators to obtain appropriate knowledge in a short time (i.e., by obtaining knowledge useful for answering inquiries from customers in a short time), it is expected to obtain the effects of reducing workload of operators, improving customer satisfaction, and the like.

### Entire Configuration Example of the Contact Center System 1

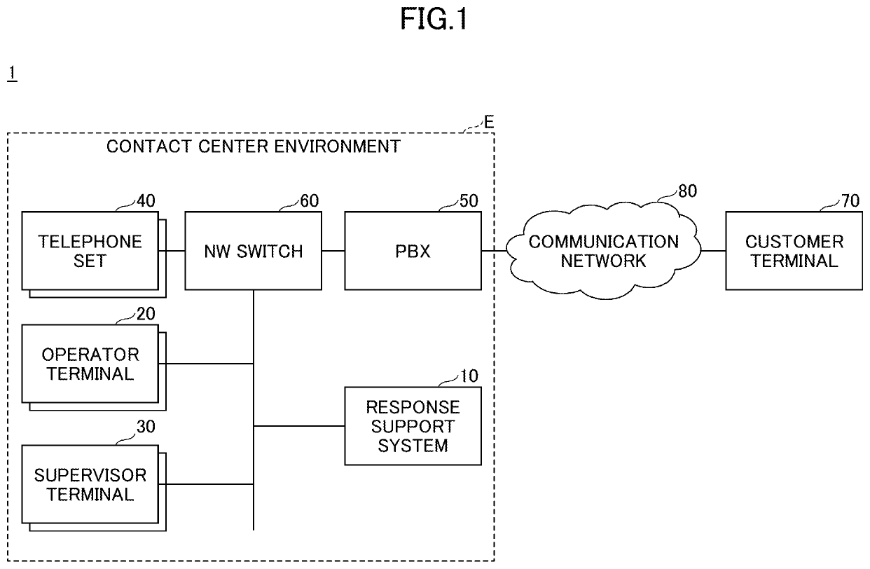

FIG. 1 is a diagram illustrating an example of the entire configuration of the contact center system 1 according to the present embodiment. As illustrated in FIG. 1, the contact center system 1 according to the present embodiment includes a response support system 10, a plurality of operator terminals 20, one or more supervisor terminals 30, a plurality of telephone sets 40, a PBX (Private Branch exchange) 50, a NW switch 60, and a customer terminal 70. Here, the response support system 10, the operator terminal 20, the supervisor terminals 30, the telephone sets 40, the PBX 50, and the NW switch 60 are installed in a contact center environment E, which is a system environment of the contact center. The contact center environment E is not limited to a system environment in the same building, but may be, for example, system environments in a plurality of geographically separated buildings.

The response support system 10 is a server, a group of servers, or the like, configured to provide various functions for supporting the operators' responses by telephone (support functions). The support functions provided by the response support system 10 are various, but in the present embodiment, at least the following support functions (1) and (2) are provided.
(1) Utterance text providing function:

This function is a function of providing a UI part expressing an utterance text that is time information-annotated texts created for respective speakers by a voice recognition technique from a voice call between an operator and a customer by using packets (voice packets) transmitted from the NW switch 60. This function enables an operator to confirm customer's and customer's utterances in real time during a call. The UI part refers to an icon, a button, a figure, a character, or the like, which is displayed on the screen. The UI part may be operable or inoperable by the user. In the following, the UI part expressing an utterance text is also referred to as an “utterance part”.
(2) Knowledge searching/providing function: This function is a function of searching knowledge, such as FAQs and the like, and providing the knowledge as the search result. This function enables an operator to confirm, for example, information necessary for answering an inquiry.

When an utterance part is selected by an operator, the response support system 10 extracts a keyword and keywords relevant to the keyword (also referred to as relevant keywords) from an utterance text expressed by the utterance part, and provides a UI part configured to perform search of knowledge with the extracted keyword. Hereinafter, the UI part configured to perform search of knowledge with a keyword is also referred to as a “search part”.

Thus, just by selecting a desired search part, the operator can perform search of knowledge with a keyword corresponding to the search part. Therefore, for example, compared to a case of manually copying a keyword from an utterance text and inputting the keyword into a search area, the operator can perform search of knowledge in a short time. Because not only a keyword but also relevant keywords are extracted, the operator can select a search part corresponding to an appropriate keyword, thereby obtaining appropriate knowledge.

The response support system 10 may be able to provide various support functions in addition to the above (1) and (2). For example, the response support system 10 may be able to provide all or some of the support functions described in the following (3) to (14).
(3) Important matter providing function:

This function is a function of providing matters that an operator needs to explain to a customer or for which an operator needs to confirm with a customer (such matters are also referred to as “important matters”). This function enables an operator to know what matters to explain to a customer, and what matters to confirm with a customer.
(4) Chat function: This function is a function of providing transmission and reception of messages with a supervisor or the like (what is referred to as a chat). For example, this function enables an operator to ask a supervisor for inquiry or support. The supervisor refers to, for example, a person who monitors operators' calls, and supports operators' responses by telephone when some problems are likely to occur or in accordance with requests by the operators.
(5) Support request function: This function is a function of requesting support from a supervisor or the like. This function enables an operator to request support from a supervisor or the like, for example, when some problems have occurred or are likely to occur.
(6) Customer information providing function: This function is a function of providing information of a customer that an operator is currently responding to (e.g., attribute information, such as his/her name, age, gender, address, history of purchase of goods and services, and the like). This function enables an operator to know various information of a customer that the operator is currently responding to.
(7) Memo function: This function is a function of allowing an operator to create a memo as desired. This function enables an operator to, for example, leave contents the operator wishes to keep, as a memo (customer interaction record memo).
(8) Previous call summary providing function: This function is a function of providing a summary of a previous call with a customer that an operator is currently responding to. This function enables an operator to confirm a summary text in which the previous call with the customer is summarized.
(9) Call summarizing function: This function is a function of creating a summary text in which call contents are summarized by using utterance texts during a call. This function enables an operator to, for example, know a summary of a call after the end of the call, or confirm a summary of a previous call by the previous call summary providing function when the operator receives a call from the same customer again.
(10) Call analyzing function: This function is a function of, by analyzing utterance texts during a call, identifying a call reason (a reason for receiving a call) or a situation (a state) of a call, or identifying whether the call is inbound or outbound. This function enables an operator to know a call reason or a situation of a customer that the operator is currently responding to. Also, for example, the important matter providing function can provide important matters in accordance with the call reason, the situation, and whether the call is inbound or outbound. Examples of the situation include initial greeting (opening), inquiry confirmation, customer identification, a response, final greeting (closing), and the like.
(11) Call history storing function: This function is a function of storing, for example, information of an operator who responded to a call, information of a customer of the call, voice data of the call, utterance texts, a summary text, and the like of the call, as call history information. This function enables, for example, utilization of call history information for analysis of response quality and evaluation of operators.
(12) Call history search function: This function is a function of searching the call history information stored by the call history storing function, and providing an operator, a supervisor, or the like with the call history information as the search results. This function enables an operator, a supervisor, and the like to search the call history information in accordance with desired search conditions, and refer to the call history information obtained as the search results.
(13) Call monitoring function: This function is a function of providing information for a supervisor to monitor calls of operators (e.g., utterance texts of their calls, inappropriate language included in the utterance texts, and the like). This function enables a supervisor to efficiently monitor calls of operators that the supervisor needs to monitor. In general, calls of several to a dozen operators are monitored by one supervisor.
(14) Analysis function: This function is a function of performing various analyses (e.g., analysis of response quality or the like) by using the call history information stored by the call history storing function. This function enables a person who wishes to provide calls of quality response (e.g., analyzers for response quality, supervisors, and the like) to analyze response quality and consider various measures and countermeasures for improving the response quality.

The above support functions (3) to (14) are merely examples. In addition to these functions, the response support system 10 may be able to provide, for example, various support functions described in Non-Patent Document 1 mentioned above.

The operator terminal 20 is a terminal used by an operator, such as a PC (personal computer) or the like.

The supervisor terminal 30 is a terminal used by a supervisor, such as a PC or the like.

The telephone set 40 is an IP (Internet Protocol) telephone set used by an operator (e. g., a landline IP telephone set, a portable IP telephone set, or the like).

The PBX 50 is a telephone exchange (IP-PBX) and is connected to a communication network 80 including a VoIP (Voice over Internet Protocol) network and a PSTN (Public Switched Telephone Network).

The NW switch 60 relays packets (voice packets) between the telephone set 40 and the PBX 50, and captures the packets and transmits the captured packets to the response support system 10.

The customer terminal 70 is various terminals used by a customer, such as a smartphone, a mobile phone, a landline telephone, and the like.

The entire configuration of the contact center system 1 illustrated in FIG. 1 is merely an example, and is by no means a limitation. Other configurations may be possible. For example, in the example illustrated in FIG. 1, the response support system 10 is included in the contact center environment E (i.e., the response support system 10 is of an on-premise type). However, all or a part of the functions of the response support system 10 may be realized by a cloud service or the like. Similarly, in the example illustrated in FIG. 1, the PBX 50 is a telephone exchange of an on-premise type, but may be realized by a cloud service. When the operator terminal 20 has a telephone function, the contact center system 1 need not necessarily include the telephone sets 40.

### Functional Configuration Example of the Response Support System 10 and the Operator Terminal 20

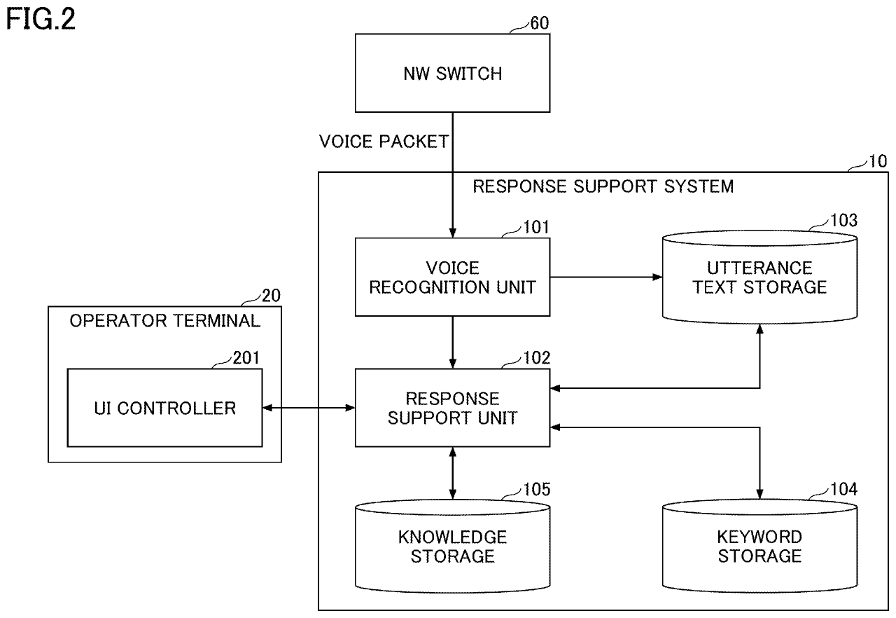

FIG. 2 illustrates a functional configuration example of the response support system 10 and the operator terminal 20 according to the present embodiment.

### Response Support System 10

As illustrated in FIG. 2, the response support system 10 according to the present embodiment includes a voice recognition unit 101 and a response support unit 102. Each of these functional units is realized, for example, through a process performed by a processor, such as a CPU (Central Processing Unit) or the like, that is executed in accordance with one or more programs installed in the response support system 10. Also, the response support system 10 according to the present embodiment includes an utterance text storage 103, a keyword storage 104, and a knowledge storage 105. Each of these storages is realized by a storage, such as an HDD (Hard Disk Drive), an SSD (Solid State Drive), a flash memory, or the like. However, at least one of these storages may be realized by a storage, such as, for example, a database server connected to the response support system 10 via a communication network.

The voice recognition unit 101 is configured to perform voice recognition on the voice expressed by voice data included in voice packets received from the NW switch 60, thereby generating time information-annotated utterance texts of respective speakers. Also, the voice recognition unit 101 is configured to store the utterance texts in the utterance text storage 103 for respective calls. By using existing voice recognition techniques, it is possible to generate time information-annotated utterance texts of respective speakers from the voice that includes utterances of a plurality of persons.

The response support unit 102 is configured to provide the operator terminal 20 with, for example, a response support screen and a UI part displayed on the screen, and provide various support functions (i.e., various support functions including at least the utterance text providing function and the knowledge searching/providing function). The response support screen and the UI part displayed on the screen are expressed by information, such as HTML (Hypertext Markup Language), CSS (Cascading Style Sheets), JavaScript, or the like.

Also, when an utterance part is selected on the response support screen, the response support unit 102 refers to the keyword information stored in the keyword storage 104, and extracts a keyword and keywords relevant to the keyword from the utterance text expressed by the selected utterance part. Then, the response support unit 102 displays, on the response support screen, a search part configured to perform search of knowledge with the extracted keyword.

The utterance text storage 103 is configured to store, for respective calls, time information-annotated utterance texts of respective speakers in the calls. In other words, the utterance text storage 103 is configured to store, for respective calls, the utterance texts of respective speakers in time series in the calls.

The keyword storage 104 is configured to store one or more pieces of keyword information. The keyword information refers to information in which a keyword is associated with keywords relevant to the keyword. For example, the keyword information is expressed in the format of (Keyword, Relevant keyword set). The relevant keyword set is a set of relevant keywords. The relevant keyword set may be, for example, an ordered set in which the relevant keywords are ordered from the highest relevance to the keyword. If there are no relevant keywords to a keyword, the relevant keyword set is an empty set.

Specific examples of the keyword information include (Cashing, {Contract, Bank}) and the like. In this keyword information, the keyword is “Cashing”, and the keywords relevant to “Cashing” are “Contract” and “Bank”.

The knowledge storage 105 is configured to store one or more pieces of knowledge information. The knowledge information refers to information in which a keyword is associated with knowledge relevant to the keyword. For example, the knowledge information is expressed in the format of (Keyword, Knowledge). This enables use of a keyword as a search key, and search of knowledge relevant to the keyword. However, the above format of knowledge information is merely an example, and the knowledge information may include, in addition to the keyword and knowledge, various information, such as, for example, the number of times of reference to knowledge, and evaluation information obtained by evaluating knowledge in accordance with criteria. Examples of the evaluation information include, for example, an average of values obtained by operators' evaluating knowledge in accordance with a graded numerical scale (e.g., an average of 5-grade evaluations), a total number of times operators evaluate knowledge to be appropriate, such as “NICE”, “GOOD”, or the like.

Although not illustrated in the example illustrated in FIG. 2, the response support system 10 includes various storages and other functional units that are utilized to realize various support functions. For example, the response support system 10 includes an operator information storage that stores operators' information including operators' ID and attributes (operators' names, operators' departments, and the like), a call history information storage that stores call history information, and the like.

### Operator Terminal 20

As illustrated in FIG. 2, the operator terminal 20 according to the present embodiment includes a UI controller 201. The UI controller 201 is realized, for example, through a process performed by a processor, such as a CPU or the like, that is executed in accordance with one or more programs (e.g., a Web browser or the like) installed in the operator terminal 20.

The UI controller 201 displays, on the display, a response support screen provided from the response support system 10. In addition, every time the UI controller 201 receives an utterance part from the response support system 10, the UI controller 201 displays the received utterance part on the response support screen dynamically (in real time). Also, when the UI controller 201 receives knowledge from the response support system 10, the UI controller 201 displays the received knowledge on the response support screen. Further, the UI controller 201 receives various input operations performed by an operator on the response support screen (e.g., pressing operations of buttons, input operations of characters, and the like).

### Response Support Process

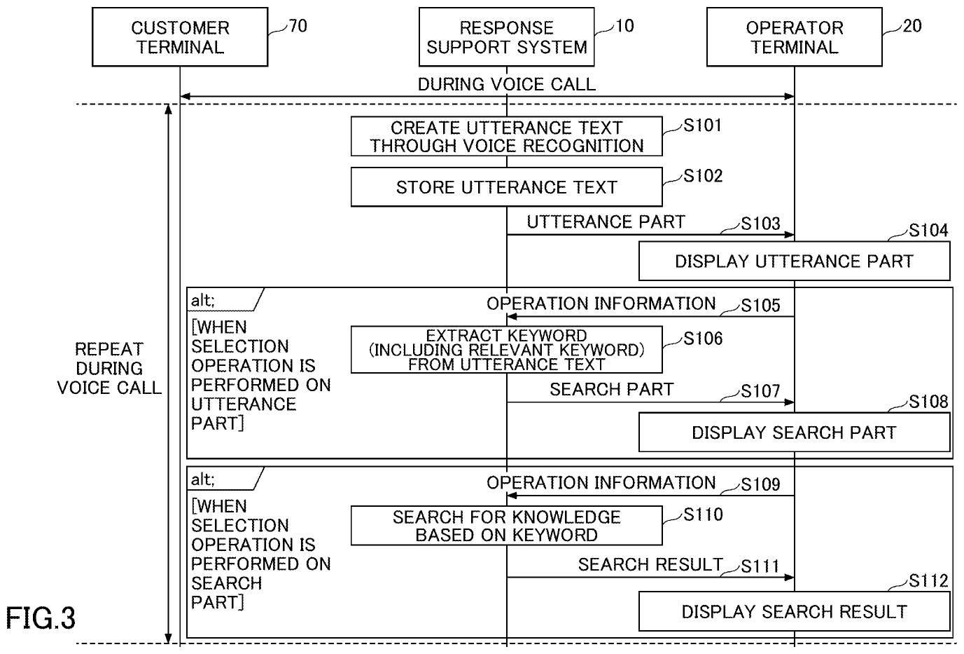

Hereinafter, assuming that a voice call between a customer and an operator is underway, a response support process for supporting an operator's response by telephone will be described with reference to FIG. 3. In the following, a response support screen is displayed by the UI controller 201 on the display of the operator terminal 20 utilized by the operator. While the voice call between the customer and the operator is underway, voice packets transmitted and received between the customer terminal 70 utilized by the customer and the operator terminal 20 utilized by the operator are transmitted (forwarded) to the response support system 10 by the NW switch 60.

The voice recognition unit 101 of the response support system 10 performs voice recognition on the voice expressed by voice data included in voice packets received from the NW switch 60, and creates time information-annotated utterance texts of respective speakers (step S101).

Next, the voice recognition unit 101 of the response support system 10 stores, in the utterance text storage 103, the utterance texts created in step S101 (step S102).

Next, the response support unit 102 of the response support system 10 transmits, to the operator terminal 20, utterance parts expressing the utterance texts created in step S101 (step S103).

When the UI controller 201 of the operator terminal 20 receives the utterance parts from the response support system 10, the UI controller 201 displays the received utterance parts on a response support screen (step S104).

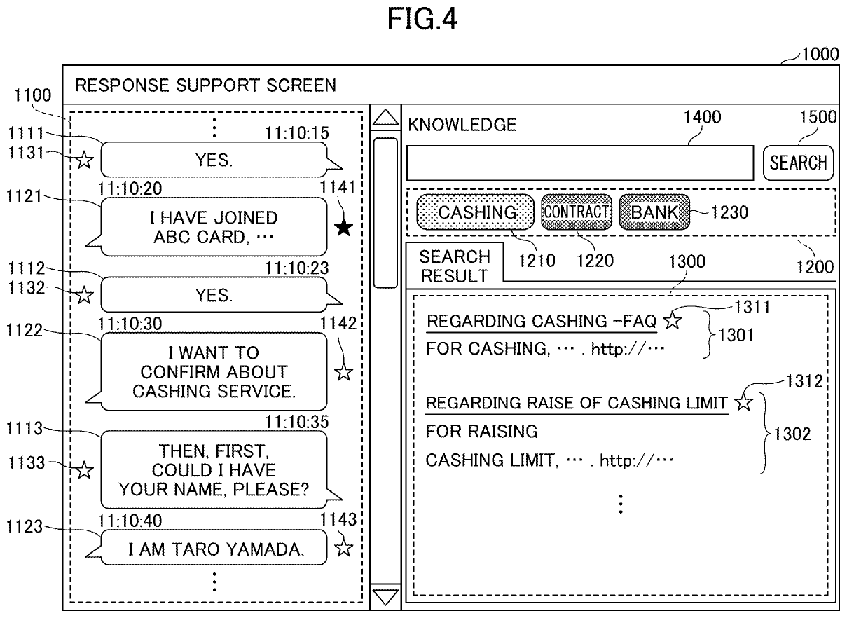

An example of the response support screen displayed by the UI controller 201 is illustrated in FIG. 4. A response support screen 1000 illustrated in FIG. 4 includes an utterance content display field 1100. The utterance content display field 1100 displays utterance parts received from the response support system 10 in time series for respective speakers. For example, in the example illustrated in FIG. 4, utterance parts 1111 to 1113 expressing the utterance texts of the operator, and utterance parts 1121 to 1123 expressing the utterance texts of the customer are displayed in time series. This enables the operator to confirm the utterance contents of the operator and the utterance contents of the customer in time series.

The utterance parts displayed in the utterance content display field 1100 may be associated with UI parts configured to evaluate that utterance texts expressed by the utterance parts are utterance texts useful for narrowing down knowledge at the time of search of knowledge (hereinafter these UI parts are also referred to as an utterance evaluation part). The utterance evaluation part may be referred to as, for example, a “NICE” button, a “GOOD” button, or the like, for the utterance text. In the example illustrated in FIG. 4, utterance evaluation parts 1131 to 1133 are respectively associated with the utterance parts 1111 to 1113, and similarly, utterance evaluation parts 1141 to 1143 are respectively associated with the utterance parts 1121 to 1123. The operator can perform a selection operation on the utterance evaluation part displayed in the utterance content display field 1100 on the response support screen 1000 illustrated in FIG. 4. For example, the operator can perform a selection operation to select a desired utterance evaluation part from the utterance evaluation parts 1131 to 1133 and 1141 to 1143 by using an input device, such as a pointing device, a touch panel, a keyboard, or the like. In the example illustrated in FIG. 4, a selection operation is performed on the utterance evaluation part 1141.

Thus, the operator can evaluate an utterance text useful for narrowing down knowledge at the time of search of knowledge, and as described below, the operator can narrow down knowledge based on a keyword included in the useful utterance text. In the example illustrated in FIG. 4, whether or not an utterance text is useful for narrowing down knowledge at the time of search of knowledge is evaluated. This is by no means a limitation. For example, an utterance text may be evaluated, for example, in accordance with a graded numerical scale.

Here, the operator can perform a selection operation on the utterance parts displayed in the utterance content display field 1100 on the response support screen 1000 illustrated in FIG. 4. For example, the operator can perform a selection operation to select a desired utterance part from the utterance parts 1111 to 1113 and 1121 to 1123, displayed in the utterance content display field 1100, by using an input device, such as a pointing device, a touch panel, a keyboard, or the like. The following description will be continued assuming that a selection operation is performed on any of the utterance parts displayed in the utterance content display field 1100 on the response support screen 1000 illustrated in FIG. 4.

The following will be described assuming that an utterance text expressed by an utterance part includes a single keyword. However, the utterance text expressed by the utterance part may include no keyword or may include a plurality of keywords. If no keyword is included in the utterance text, no keyword is extracted in step S106 described below. On the other hand, if a plurality of keywords are included in the utterance text, for example, all the keywords may be extracted in step S106 described below. Alternatively, every time a selection operation is performed on the utterance part, the keywords may be extracted in order from the keyword that appears for the first time in the utterance text.

When a selection operation is performed on the utterance part, the UI controller 201 of the operator terminal 20 transmits, to the response support system 10, operation information indicating that the utterance part was selected (step S105). The operation information includes, for example, identification information of the utterance part on which the selection operation was performed (e.g., part ID or the like). However, instead of the operation information, for example, the UI controller 201 of the operator terminal 20 may transmit, to the response support system 10, the utterance text expressed by the utterance part, or the identification information of the utterance text expressed by the utterance part (e.g., utterance text ID or the like).

When the response support unit 102 of the response support system 10 receives the operation information from the operator terminal 20, the response support unit 102 extracts a keyword (including relevant keywords) from the utterance text expressed by the utterance part with the part ID included in the operation information (step S106). That is, the response support unit 102 refers to the keyword information stored in the keyword storage 104, and extracts a keyword from the utterance text and extracts keywords relevant to the keyword. A set of a keywords and keywords relevant to the keyword (relevant keywords) may be referred to as a “preset”, a “keyword preset”, or the like.

For example, it is assumed that keyword information (Cashing, {Contract, Bank}) or the like is stored in the keyword storage 104, and a selection operation is performed on the utterance part 1122 displayed in the utterance content display field 1100 on the response support screen 1000 illustrated in FIG. 4. In this case, the response support unit 102 extracts keyword “Cashing” from the utterance text “I want to confirm about cashing service” expressed by the utterance part 1122, and extracts keywords “Contract” and “Bank” relevant to the keyword “Cashing”.

Next, the response support unit 102 of the response support system 10 transmits, to the operator terminal 20, a search part configured to perform search of knowledge with the keywords extracted in step S106 (step S107).

For example, when the keywords extracted in step S106 are “Cashing”, “Contract”, and “Bank”, a search part configured to perform search of knowledge with “Cashing”, a search part configured to perform search of knowledge with “Contract”, and a search part configured to perform search of knowledge with “Bank” are transmitted to the operator terminal 20.

When the UI controller 201 of the operator terminal 20 receives the search parts from the response support system 10, the UI controller 201 displays these search parts on the response support screen (step S108). These search parts are displayed, for example, in a search part display field 1200 of the response support screen 1000 illustrated in FIG. 4. For example, the search part corresponding to the keyword extracted from the utterance text is displayed on the leftmost side (at a display position with the highest priority). The search parts corresponding to the relevant keywords may be, for example, displayed sequentially from left in order from the highest relevance to the keyword, or displayed sequentially from left in order of extraction of the relevant keywords. For example, in the example illustrated in FIG. 4, a search part 1210 corresponding to the keyword “Cashing” is displayed on the leftmost side (at a display position with the highest priority), a search part 1220 corresponding to the relevant keyword “Contract” is displayed next (at a display position with the second highest priority), and a search part 1230 corresponding to the relevant keyword “Bank” is displayed next (at a display position with the third highest priority). It is considered that the search part at the display position with higher priority is more likely to provide appropriate knowledge when performing search of knowledge with the keyword corresponding to the search part.

The search part corresponding to the keyword and the search part corresponding to the relevant keyword may be different in terms of a display mode (e.g., the color of the UI part, or the like). The example illustrated in FIG. 4 illustrates a case in which the display mode of the search part 1210 corresponding to the keyword is different from the display mode of the search parts 1220 and 1230 corresponding to the relevant keywords.

Here, the operator can perform a selection operation on the search part displayed in the search part display field 1200 on the response support screen 1000 illustrated in FIG. 4. For example, the operator can perform a selection operation to select a desired search part from the search parts 1210 to 1230, displayed in the search part display field 1200, by using an input device, such as a pointing device, a touch panel, a keyboard, or the like. The following description will be continued assuming that a selection operation is performed on any of the search parts displayed in the search part display field 1200 on the response support screen 1000 illustrated in FIG. 4.

When a selection operation is performed on the search part, the UI controller 201 of the operator terminal 20 transmits, to the response support system 10, operation information indicating that the search part was selected (step S109). The operation information includes, for example, identification information (e.g., part ID or the like) of the search part on which the selection operation was performed. However, instead of the operation information, for example, the UI controller 201 of the operator terminal 20 may transmit, to the response support system 10, the keyword corresponding to the search part, or the identification information of the keyword corresponding to the search part (e.g., keyword ID or the like).

When the response support unit 102 of the response support system 10 receives the operation information from the operator terminal 20, the response support unit 102 performs search of knowledge with a keyword corresponding to the search part with the part ID included in the operation information (step S110). That is, the response support unit 102 performs search of knowledge information stored in the knowledge storage 105 by using the keyword as a search key, and obtains knowledge information relevant to the keyword as a search result.

For example, when the operator performs a selection operation on the search part 1210, search of knowledge information stored in the knowledge storage 105 is performed by using, as a search key, the keyword “Cashing” corresponding to the search part 1210. Thus, search of knowledge information relevant to the keyword “Cashing” is performed. An existing method may be used as a searching method for knowledge.

Here, when an utterance evaluation part is selected by the operator, search of knowledge is performed by using, as an AND condition, a keyword included in an utterance text associated with the utterance evaluation part in step $110. For example, when the utterance evaluation part 1141 is selected on the response support screen 1000 illustrated in FIG. 4, search of knowledge is performed by using, as an AND condition, keyword “ABC card” included in the utterance text associated with the utterance evaluation part 1141.

Specifically, for example, when a keyword corresponding to the search part on which a selection operation is performed by the operator is “Cashing”, search of knowledge information is performed by using “Cashing” and “ABC card” as search keys. In this manner, when an utterance evaluation part is selected by the operator, knowledge can be narrowed down by the keyword included in the utterance text associated with the utterance evaluation part at the time of search of knowledge.

Next, the response support unit 102 of the response support system 10 transmits, to the operator terminal 20 as a search result, knowledge included in the knowledge information searched in step S110 and information involved with the knowledge (step S111). Examples of the information involved with the knowledge include the number of times of reference to the knowledge, evaluation information of the knowledge, and the like.

When the UI controller 201 of the operator terminal 20 receives the search result from the response support system 10, the UI controller 201 displays the received search result on the response support screen (step S112). This search result is displayed, for example, in a search result display field 1300 of the response support screen 1000 illustrated in FIG. 4. The search result display field 1300 illustrated in FIG. 4 displays knowledge 1301 and knowledge 1302 as the search result. By selecting desired knowledge from the knowledge displayed in the search result display field 1300, more detailed information of the selected knowledge may be displayed.

In the search result display field 1300, the knowledge obtained as the search result may be displayed in order of display in accordance with the information involved with the knowledge. For example, the knowledge may be displayed in order from the largest number of times of reference to the knowledge. Alternatively, the knowledge may be displayed in order from the best evaluation expressed by the evaluation information (e.g., in order from the largest total number of “NICE”, “GOOD”, or the like, in order from the highest average of the values evaluated in accordance with a graded numerical scale, or the like).

The knowledge displayed in the search result display field 1300 may be associated with a UI part configured to evaluate that the knowledge is useful for answering inquiries (hereinafter also referred to as a knowledge evaluation part). The knowledge evaluation part may be referred to as, for example, a “NICE” button, a “GOOD” button, or the like, for the knowledge. In the example illustrated in FIG. 4, knowledge 1301 and knowledge 1302 are respectively associated with a knowledge evaluation part 1311 and a knowledge evaluation part 1312. The operator can perform a selection operation on the knowledge evaluation part displayed in the search result display field 1300 on the response support screen 1000 illustrated in FIG. 4. For example, the operator can perform a selection operation to select a desired knowledge evaluation part from the knowledge evaluation parts 1311 and 1312 by using an input device, such as a pointing device, a touch panel, a keyboard, or the like. When the selection operation is performed on the knowledge evaluation part, operation information indicating that the knowledge evaluation part was selected is transmitted to the response support system 10. As a result, in the knowledge information stored in the knowledge storage 105, the evaluation information of the knowledge information including the knowledge associated with the knowledge evaluation part is updated.

Regarding the knowledge obtained as the search result, the display order of the knowledge useful for answering inquiries (i.e., quality knowledge) can be higher, and the display order of the knowledge not useful can be lower.

As described above, according to the contact center system 1 according to the present embodiment, an operator just performs a selection operation on an utterance part expressing a customer's or operator's utterance text, and thus can display, on the response support screen, a search part configured to perform search of knowledge with a keyword and relevant keywords included in the utterance text. Then, the operator just performs a selection operation on a desired search part on the response support screen, and thus can perform search of knowledge with a keyword corresponding to the search part. This enables the operator to perform search of knowledge in a short time. Also, search parts corresponding to not only a keyword but also relevant keywords are displayed, and thus the operator can select a search part corresponding to an appropriate keyword from these search parts. This enables the operator to obtain appropriate knowledge.

Therefore, according to the contact center system 1 according to the present embodiment, the operator can provide a customer with an appropriate answer without keeping the customer waiting when responding to an inquiry from the customer. As a result, for example, it is possible to contribute to increased customer satisfaction.

Similar to existing cases, an operator inputs a desired keyword into a search area 1400 on the response support screen 1000 illustrated in FIG. 4 and presses a search button 1500, and thus can perform search of knowledge relevant to the keyword.

### MODIFIED EXAMPLES

Hereinafter, Modified Examples of the present embodiment will be described.

### Modified Example 1

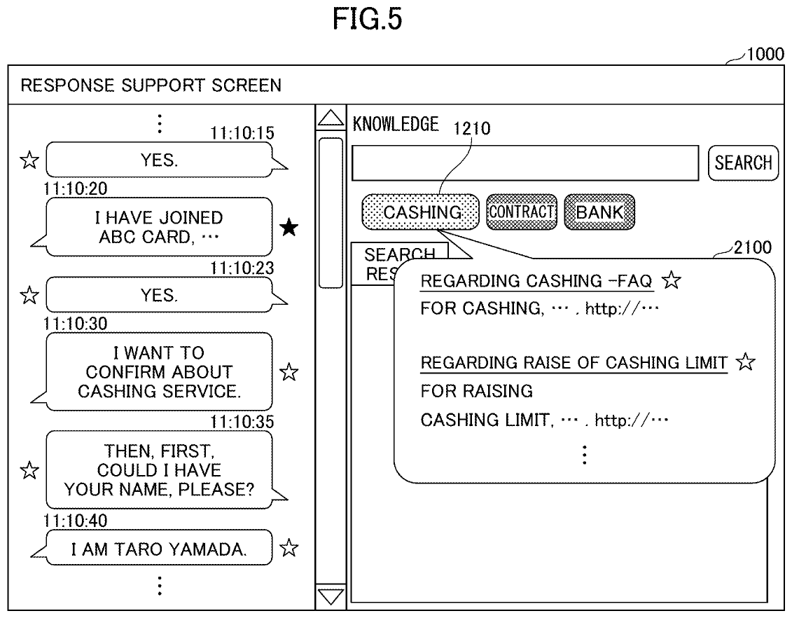

In the above embodiments, search of knowledge is performed in response to the selection operation performed on the search part. However, for example, search of knowledge may be performed in advance with a keyword (including relevant keywords) extracted from an utterance part, and in response to mouse-over performed on a search part, a search result in accordance with a keyword corresponding to the search part (or several top knowledge items included in the search result) may be displayed as a pop-up. For example, when mouse-over is performed on the search part 1210 on the response support screen 1000 illustrated in FIG. 5, a search result in accordance with the keyword corresponding to the search part 1210 may be displayed on a pop-up screen 2100.

By this, the operator just performs mouse-over on a search part, and thus can readily confirm what search results are obtained when performing search of knowledge with a keyword corresponding to the search part.

### Modified Example 2

In the above embodiments, there may be a case in which appropriate knowledge is not obtained depending on a keyword extracted from the utterance text expressed by the utterance part. For example, when the keyword extracted from the utterance text is an abstract term, a term with different meanings, or the like, many knowledge items may be obtained as the search result, and narrowing-down may be insufficient. Therefore, when the keyword extracted from the utterance text expressed by the utterance part is a specific keyword (e.g., a keyword expressing an abstract term, a term with different meanings, or the like), suggestions (proposals/recommendations) for narrowing down knowledge may be provided to an operator at the time of search of knowledge.

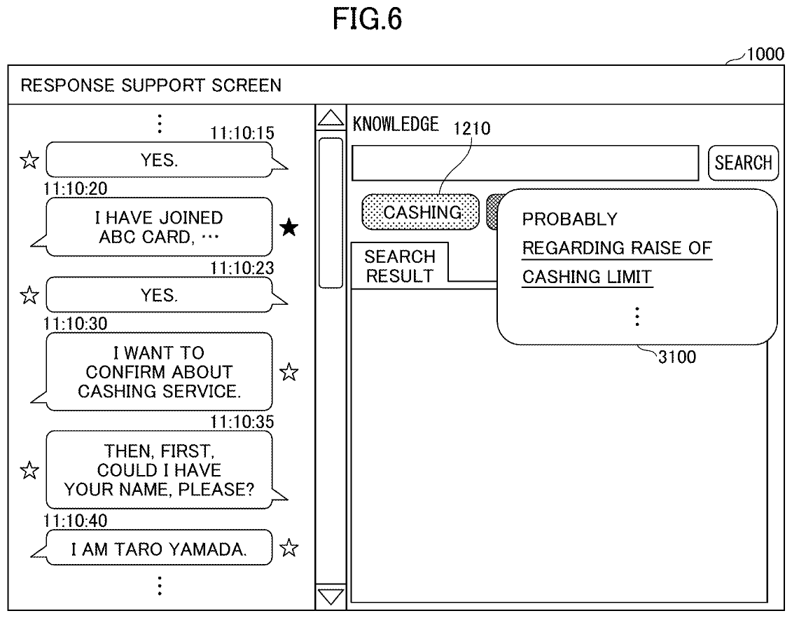

For example, on the response support screen 1000 illustrated in FIG. 6, an operator is provided with a suggestion 3100 for further narrowing down knowledge when the operator performs search of knowledge with the keyword “Cashing” corresponding to the search part 1210. A search result obtained when further narrowing down knowledge for search with the keyword “Cashing” is displayed in the suggestion 3100.

By this, an operator can obtain appropriate knowledge even if the keyword extracted from the utterance text expressed by the utterance part is a keyword expressing an abstract term or a term with different meanings.

### Modified Example 3

When a plurality of keywords are included in the utterance text expressed by the utterance part, in accordance with a position at which a selection operation is performed on the utterance part (operation position), the keyword located at a position closest to the operation position may be extracted in step S106.

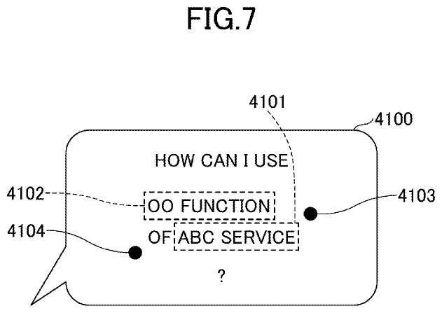

For example, it is assumed that a selection operation is performed on an utterance part 4100 illustrated in FIG. 7. Here, the utterance text expressed by the utterance part 4100 includes a keyword 4101 of “ABC service” and a keyword 4102 of: “00 function”. If, for example, a selection operation is performed on an operation position 4103, the keyword 4101 is extracted in step S106. If, for example, a selection operation is performed on an operation position 4104, the keyword 4102 is extracted in step S106.

By this, an operator can extract a desired keyword alone from the utterance text expressed by the utterance part in accordance with the operation position of an operation performed by the operator.

### Modified Example 4

Although the keyword and the relevant keywords are extracted in step S106, for example, the keyword alone may be extracted without extracting the relevant keywords. When the keyword alone is extracted, search of knowledge may be automatically performed by the extracted keyword, and a search result may be presented to the operator. By this, an operator just performs a selection operation on an utterance part, and thus can perform search of knowledge in accordance with a keyword included in the utterance text expressed by the selected utterance part. This enables an operator to perform search of knowledge in a shorter time.

### Modified Example 5

When displaying search parts corresponding to relevant keywords on the response support screen, priority (order of display) of the search parts may be determined in accordance with a relationship with a topic of a conversation between a customer and an operator. For example, after determining the topic of the conversation between the customer and the operator, certainty (e.g., probability or the like) that the relevant keywords are the topic may be determined, and then the priority (order of display) of the search parts corresponding to the relevant keywords may be determined in order from the highest certainty. A topic may be determined by an existing topic determination technique.

### Modified Example 6

For example, the search parts displayed on the response support screen may be deleted every time a selection operation is performed on the utterance part, or may be added every time a selection operation is performed on the utterance part. When the search parts are added every time a selection operation is performed on the utterance part, the search parts may be deleted in order from the oldest search part when exceeding the maximum number of search parts that are displayable on the response support screen.

The present invention is not limited to the above specifically disclosed embodiments.

Various modifications, alterations, combinations with existing techniques, and the like are possible without departing from the claims recited.

### REFERENCE SIGNS LIST

1 Contact center system
10 Response support system
20 Operator terminal
30 Supervisor terminal
40 Telephone set
50 PBX
60 NW switch
70 Customer terminal
80 Communication network
101 Voice recognition unit
102 Response support unit
103 Utterance text storage
104 Keyword storage
105 Knowledge storage
201 UI controller
E Contact center environment

1. An information processing device, comprising:
a memory; and
at least one processor connected to the memory, wherein the processor is configured to:
extract, in response to a selection operation on a first display part that indicates a text of an utterance in a conversation between a plurality of persons, a predetermined first character string from the text; and
perform search, based on the extracted first character string as a search key, knowledge data, wherein the knowledge data represent information for supporting generation of a response to an inquiry in the conversation.

2. The information processing device according to claim 1, wherein
the extract operation further comprises extracting a second character string that corresponds to the first character string in a predetermined keyword information, and
the perform the search operation further comprises, in response to a selection operation on a second display part that causes performing the search based on the second character string as the search key, performing a search for the knowledge data based on the search key.

3. The information processing device according to claim 2, wherein
the second display part displays the second character string on a user interface according to a priority from the highest relevance between the second character string and the first character string, or a level of relevance between a topic of the second character string and a topic of the conversation.

4. The information processing device according to claim 1, wherein
the extract operation further comprises extracting a second character string, wherein the second character string is relevant to the first character string,
the perform the search operation further comprises performing the search based on search keys that include the first character string and the second character string, and
the processor is further configured to display, in response to an overlap operation of a pointer position overlapping with a second display part, on a user interface, the knowledge data obtained as a search result of the search.

5. The information processing device according to claim 1, wherein
the processor is configured to
perform the search of the knowledge data based on the search key as evaluated by a user to express a useful utterance.

6. The information processing device according to claim 1, wherein
the processor is further configured to
display, on a user interface, the knowledge data obtained as a search result in order based on evaluation information of the knowledge.

7. The information processing device according to claim 1, wherein
the first character string is located the closest to a position of the first display part at which the selection operation is performed.

8. An information processing method executed by a computer, comprising:
extracting, in response to a selection operation on a first display part that indicates a text of an utterance in a conversation between a plurality of persons, a predetermined first character string from the text; and
performing search, based on the extracted first character string as a search key, knowledge data, wherein the knowledge data represent information for supporting generation of a response to an inquiry in the conversation.

9. A non-transitory computer-readable recording medium storing a program that causes a computer to execute:
extracting, in response to a selection operation on a first display part that indicates a text of an utterance in a conversation between a plurality of persons, a predetermined first character string from the text; and
performing search, based on the extracted first character string as a search key, knowledge data, wherein the knowledge data represent information for supporting generation of a response to an inquiry in the conversation.

10. The information processing device according to claim 1, wherein
the extract operation further comprises extracting a second character string, wherein the second character string is relevant to the first character string,
the perform the search operation further comprises performing the search based on search keys that include the first character string and the second character string, and
the processor is further configured to display, in response to an overlap operation of a pointer position overlapping with a second display part, on a user interface, the knowledge data according to a predetermined number of top knowledge data of the knowledge data obtained as a search result of the search.
